(19) United States
(12) Patent Application Publication
(10) Pub. No.: US 2008/0104869 A1
(43) Pub. Date: May 8, 2008

(54) Bubble display system

(76) Inventor: Hsu-Cheng Wang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/591,597

(22) Filed: Nov. 2, 2006

(51) Int. Cl. G09F 19/00

(52) U.S. Cl. 40/406

(57) ABSTRACT

A bubble display system is disclosed to include an aquarium holding multiple color liquids that have different specific gravities and are floating on one another at different levels inside the aquarium, multiple bubble generators merged in the bottom liquid inside the aquarium, multiple water pipes arranged outside the aquarium and respectively connected between the liquids and the bubble generators and respectively mounted with a respective electromagnetic valve, and a control circuit for driving the pumps, the electromagnetic valves and the bubble generators to cause the liquids to circulate through the bubble generators and to produce moving lines of color bubbles in the aquarium.

### BACKGROUND OF THE INVENTION

1. Field of the Invention:

The present invention relates to display toys and more particularly, to a bubble display system that holds multiple liquids of different specific gravities at different levels and multiple pumping systems to cause circulation of the liquids through different bubble generators for producing moving lines of color bubbles.

2. Description of the Related Art:

A conventional bubble display system is known comprising an aquarium holding a liquid, a high-capacity pump operable to pump the liquid through different water passages and bubble generators for producing moving lines of bubbles in the aquarium, and color projector lamps for emitting different colors of light toward the liquid in the aquarium. This design of aquarium is still not satisfactory in function due to the following drawbacks:

1. The use of a high-capacity pump consumes much electric energy and causes noises during operation.

2. Because this design uses a high-capacity pump to pump water for producing bubbles, water bubbles do not last for long.

3. Because water bubbles and the water in the aquarium have a similar color, the projection of different colors of light from different color projector lamps does not cause an attractive color effect.

### SUMMARY OF THE INVENTION

The present invention has been accomplished under the circumstances in view. It is the main object of the present invention to provide a bubble display system, which saves power consumption and does not cause noises during operation. It is another object of the present invention to provide a bubble display system, which produces an attractive visual effect during operation. To achieve these and other objects of the present invention, the bubble display system comprises an aquarium holding multiple color liquids that have different specific gravities and are floating on one another at different levels inside the aquarium, multiple bubble generators merged in the bottom liquid inside the aquarium, multiple water pipes arranged outside the aquarium and respectively connected between the liquids and the bubble generators and respectively mounted with a respective electromagnetic valve, and a control circuit for driving the pumps, the electromagnetic valves and the bubble generators to cause the liquids to circulate through the bubble generators and to produce moving lines of color bubbles in the aquarium.

Further, color projector lamps are mounted on the top and bottom sides outside the aquarium, and controllable by the control circuit to emit light toward the liquids in the aquarium from different directions.

Further, a voice controller is electrically connected to the control circuit for receiving sound and for actuating the control circuit to drive on the bubble generators, the pumps and the electromagnetic valves when received a sound.

### BRIEF DESCRIPTION OF THE DRAWINGS

FIG. 1 is a sectional view of a bubble display system in accordance with the present invention.

FIG. 2 is a schematic drawing, showing moving lines of bubbles produced in the liquids in the aquarium of the bubble display system according to the present invention.

FIG. 3 is an elevational view of a bubble generator for the bubble display system according to the present invention.

FIG. 4 is a top view of the bubble generator shown in FIG. 3.

FIG. 5 is a sectional side view of FIG. 2.

FIG. 6 is a sectional view of an alternate form of the bubble display system according to the present invention.

FIG. 7 is a sectional view of another alternate form of the bubble display system according to the present invention.

### DETAILED DESCRIPTION OF THE PREFERRED EMBODIMENT

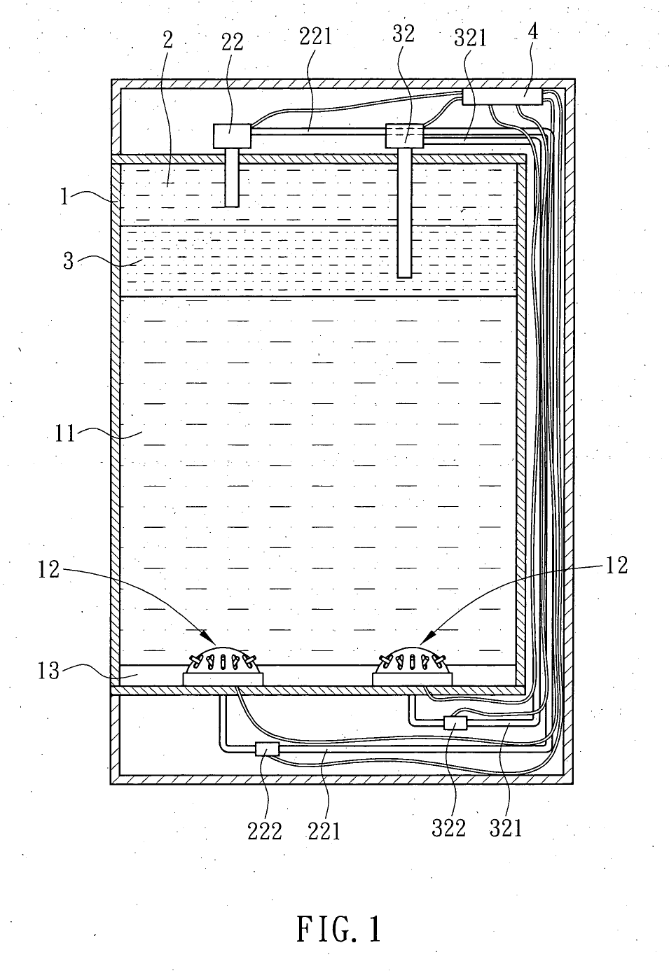

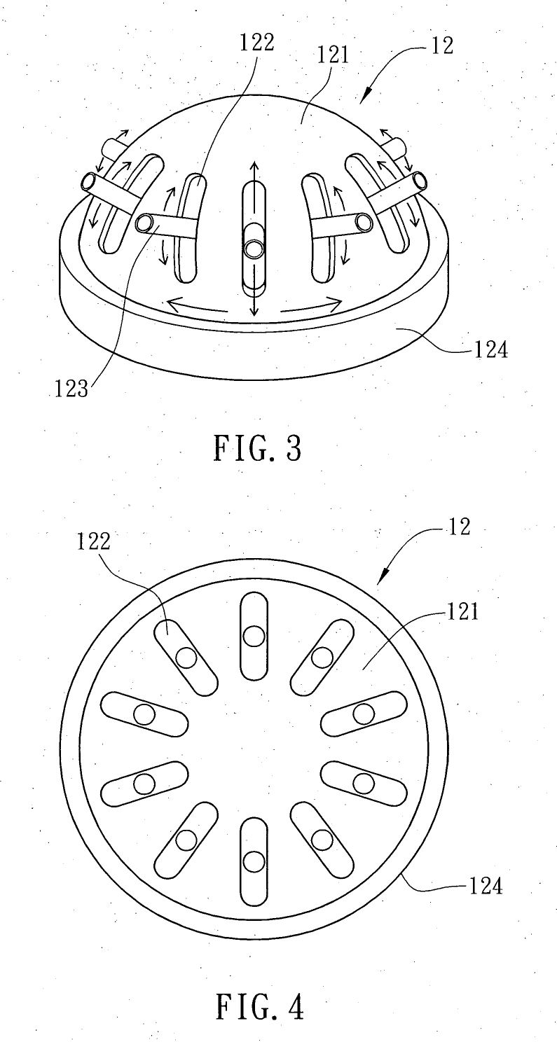

Referring to FIGS. 1-4, a bubble display system in accordance with the present invention is shown comprising an aquarium 1 filled up with different liquids, for example, three different liquids, namely, the bottom-layer liquid 11, the top-layer liquid 2, and the intermediate-layer liquid 3 that have different specific gravities. Because these liquids 11, 2 and 3 have different specific gravities, they are floating one on another in the aquarium 1 at different levels. These liquids 11, 2, 3 include water 11, a first oil 2, and a second oil 3. Further, these liquids 11, 2 and 3 are respectively colored with a different color. Two bubble generators 12 are mounted in the bottom side inside the aquarium 1 and merged in the first liquid 11. A first pump 22 and a second pump 32 are mounted in the top side of the aquarium 1 and respectively inserted into the top-layer liquid 2 and the intermediate-layer liquid 3, and adapted to pump the top-layer liquid 2 and the intermediate-layer liquid 3 to the bubble generators 12 through a respective water pipe 221 or 321. An electromagnetic valve 222 or 322 is mounted in the water pipe 221 or 321. A control circuit 4 is provided outside the aquarium 1 and adapted to control the operation of the bubble generators 12, the pumps 22 and 32 and the electromagnetic valves 222 and 322. Each bubble generator 12 comprises a base 124, a rotating dome 121 supported on the base 124, a plurality of oscillating nozzles 123 respectively movably extending out of respective slots 122 on the rotating dome 121 and connected to the water pipe 221 or 321, and a servo motor and transmission set (not shown) controlled by the control circuit 4 to rotate the rotating dome 121 and to oscillate the oscillating nozzles 123 in the slots 122. During operation, the pumps 22 and 32 pump the top-layer liquid 2 and the intermediate-layer liquid 3 to circulate through aquarium 1, the respective water pipes 221 and 321 and the bubble generators 12, thereby producing moving lines of bubbles of different colors in the aquarium 1.

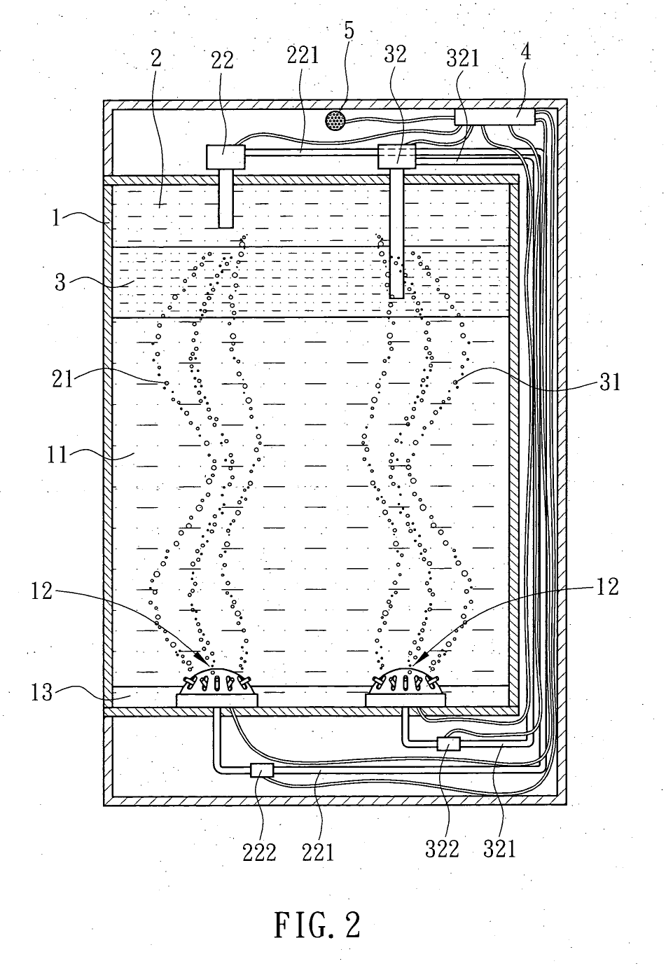

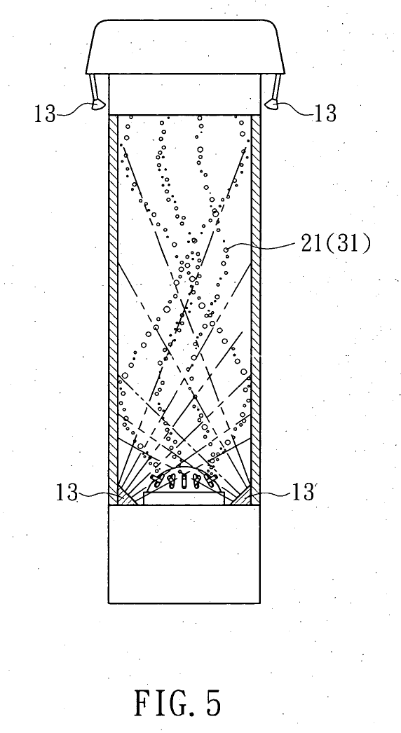

Referring to FIG. 5 and FIG. 2 again, color projector lamps 13 are mounted on top and bottom sides outside the aquarium 1 and controlled by the control circuit 4 to emit light toward the liquids 11, 2 and 3 from different directions, thereby producing a lighting effect. Further, a voice controller 5 is provided for receiving sound, and controlling the control circuit 4 to drive on the bubble generators 12, the pumps 22 and 32 and the electromagnetic valves 222 and 322 when received a loud sound.

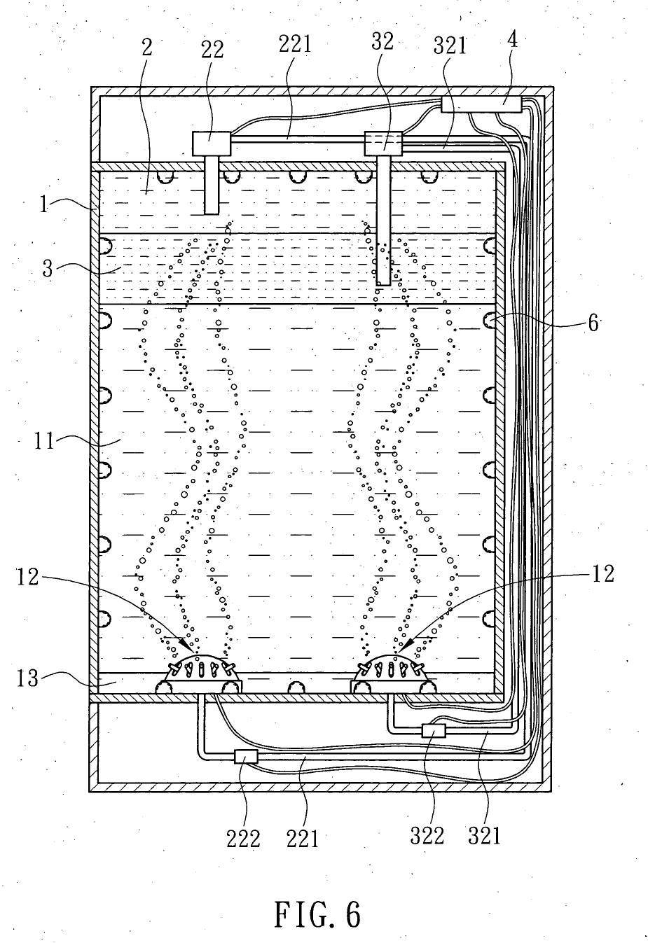

FIG. 6 shows an alternate form of the present invention. This embodiment is substantially similar to the embodiment shown in FIGS. 1-5 with the exception that infrared sensors 6 are mounted in the aquarium 1 at different locations and electrically connected to the control circuit 4. When a person is approaching the hand to the infrared sensors 6, the control circuit 4 is initiated to start the pumps the bubble generators 12, the pumps 22 and 32 and the electromagnetic valves 222 and 322.

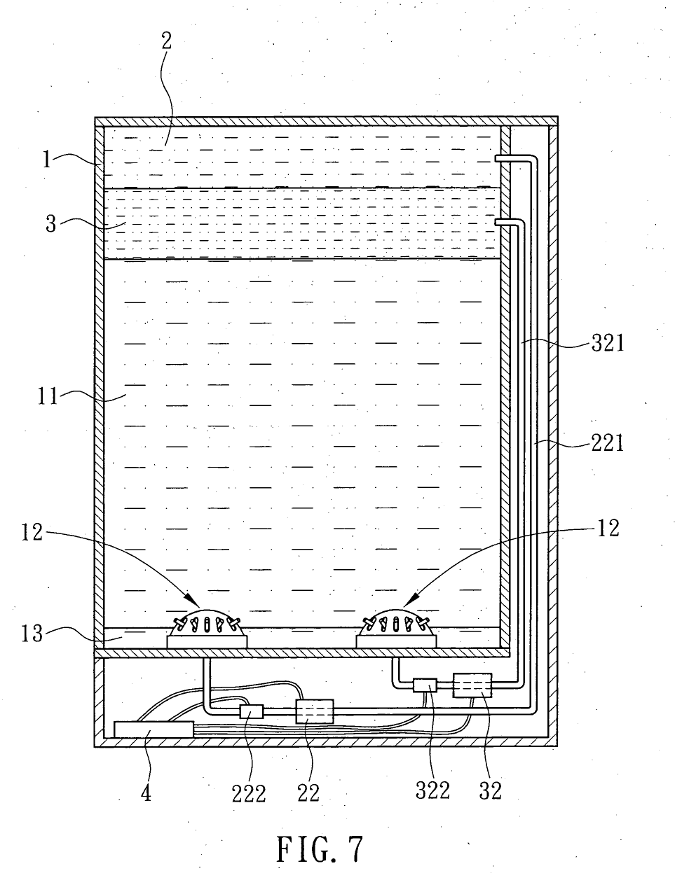

FIG. 7 shows another alternate form of the present invention. According to this embodiment, the control circuit 4 and the pumps 22 and 32 are provided at the bottom side of the aquarium 1; the pumps 22 and 32 are respectively installed in the water pipes 221 and 321 that are arranged outside the aquarium 1, each having one end connected to one bubble generator 12 and the other end merged in the top-layer liquid 2 or intermediate-layer liquid 3. This embodiment achieves the same various effects as the embodiments shown in FIGS. 1-6.

A prototype of bubble display system has been constructed with the features of FIGS. 1-7. The bubble display system functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A bubble display system comprising:
an aquarium holding multiple liquids having different specific gravities, said liquids being respectively colored with a respective color and floating on one another at different levels inside said aquarium;
a plurality of bubble generators mounted in a bottom side inside said aquarium and merged in the bottom liquid inside said aquarium;
a plurality of pumps mounted in a top side inside said aquarium and respectively inserted into said liquids;
a plurality of water pipes arranged outside said aquarium and respectively connected between said bubble generators and said pumps;
a plurality of electromagnetic valves respectively installed in said water pipes between said bubble generators and said pumps; and
a control circuit provided outside said aquarium and adapted to control the operation of said bubble generators, said pumps and said electromagnetic valves, causing said pumps to pump said liquids respectively out of said aquarium through said water pipes and said electromagnetic valves into said bubble generators to produce color bubbles in said liquid inside said aquarium.

2. The bubble display system as claimed in claim 1, wherein said bubble generators each comprise a base, a rotating dome rotatably supported on said base, said rotating dome having a plurality of slots, a plurality of oscillating nozzles respectively movably extending out of said slots and respectively connected to said water pipe, and a servo motor and transmission set controllable by said control circuit to rotate said rotating dome on said base and to oscillate said oscillating nozzles in said slots.

3. The bubble display system as claimed in claim 1, further comprising a voice controller electrically connected to said control circuit for receiving sound and for actuating said control circuit to drive on said bubble generators, said pumps and said electromagnetic valves when received a sound.

4. The bubble display system as claimed in claim 1, further comprising a plurality of color projector lamps mounted on top and bottom sides outside said aquarium and controllable by said control circuit to emit light toward said liquids in said aquarium from different directions.

5. The bubble display system as claimed in claim 1, further comprising a plurality of infrared sensors mounted in said aquarium at different locations and electrically connected to said control circuit for actuating said control circuit to drive on said bubble generators, said pumps and said electromagnetic valves upon approaching of a part of a person.

6. A bubble display system comprising:
an aquarium holding multiple liquids having different specific gravities, said liquids being respectively color,ed with a respective color and floating on one another at different levels inside said aquarium;
a plurality of bubble generators mounted in a bottom side inside said aquarium and merged in the bottom liquid inside said aquarium;
a plurality of water pipes arranged outside said aquarium, said water pipes each having one end respectively connected to said bubble generators and an opposite end respectively inserted into said liquids;
a plurality of pumps respectively installed in said water pipes;
a plurality of electromagnetic valves respectively installed in said water pipes between said bubble generators and said pumps; and
a control circuit provided outside said aquarium and adapted to control the operation of said bubble generators, said pumps and said electromagnetic valves, causing said pumps to pump said liquids respectively out of said aquarium through said water pipes and said electromagnetic valves into said bubble generators to produce color bubbles in said liquid inside said aquarium.
